(19) United States
(12) Patent Application Publication
(10) Pub. No.: US 2011/0109501 A1
(43) Pub. Date: May 12, 2011

(54) AUTOMATED BEAM PEAKING SATELLITE GROUND TERMINAL

(75) Inventors: David W. Corman, Gilbert, AZ (US); Friedhelm Wachter, Phoenix, AZ (US); Kenneth V. Buer, Gilbert, AZ (US)

(73) Assignee: VIASAT, INC., Carlsbad, CA (US)

(21) Appl. No.: 12/758,966

(22) Filed: Apr. 13, 2010

Related U.S. Application Data
(60) Provisional application No. 61/259,053, filed on Nov. 6, 2009.
(60) Provisional application No. 61/259,047, filed on Nov. 6, 2009.
(60) Provisional application No. 61/259,049, filed on Nov. 6, 2009.

(51) Int. Cl. H01Q 3/00; H01Q 3/12; H04B 7/185

(52) U.S. Cl. 342/354; 343/761; 342/372

(57) ABSTRACT

This disclosure may relate generally to systems, devices, and methods for a phased array illuminated reflector dish RF antenna combining a phased array with a microwave reflector dish and using beam steering to align the antenna beam to maximize antenna performance. The phased array may be connected in communication with one of a transmitter, a receiver, and a transceiver. In various exemplary embodiments the phased array illuminated reflector dish RF antenna includes a boom arm supporting the microwave reflector dish and the phased array. In one exemplary embodiment, the phased array only communicates signals with a remote source of the signals via the microwave reflector dish (not directly). The RF antenna system may be configured to be rough pointed by mechanically aiming the RF antenna system, and the RF antenna system is configured to fine tune aim the beam of said RF antenna system by beam steering.

### CROSS REFERENCE TO RELATED APPLICATIONS

This application is a non-provisional of U.S. Provisional Application No. 61/259,053, entitled “ELECTROMECHANICAL POLARIZATION SWITCH,” which was filed on Nov. 6, 2009. This application is also a non-provisional of U.S. Provisional Application No. 61/259,047, entitled “AUTOMATED BEAM PEAKING SATELLITE GROUND TERMINAL,” which was filed on Nov. 6, 2009. This application is a non-provisional of U.S. Provisional Application No. 61/259,049, entitled “DYNAMIC REAL-TIME POLARIZATION FOR ANTENNAS,” which was filed on Nov. 6, 2009. All of the contents of the previously identified applications are hereby incorporated by reference for any purpose in their entirety.

### FIELD OF THE INVENTION

The subject of this disclosure may relate generally to systems, devices, and methods for an antenna combining a phased array with a microwave reflector dish and using beam steering to align the antenna beam to the beam peak to maximize antenna performance.

### BACKGROUND

In the field of consumer broadband internet services delivered via satellite, and in other related point to point radio frequency (“RF”) communication, a considerable effort is expended in accurately aiming the antennas. A poorly aimed antenna may drastically degrade performance of the communication system. The performance limitations brought on by mis-aiming an antenna may be described in several different ways. For example, results of mis-aiming an antenna may be described in terms of satellite link interference, off-axis interference into other satellites, transmission interference, degraded reception, and/or the like.

The interference arises in part because the less an antenna is pointing directly at the intended satellite, the more it is pointing at an unintended satellite. Thus, a sent signal may interfere with communications on an unintended satellite, and an unintended satellite may interfere with the mis-pointed antenna. Moreover, signal strength at the receiving antenna is reduced when the aiming (on either the sending or receiving antenna) is off by even a small amount.

For example, communication between a 70 cm effective aperture size ground terminal and a geostationary satellite at 30 GHz typically requires that high gain antennas be employed. Since high gain antennas provide very narrow beam widths, if aiming is off even a few tenths of a degree, the power may be reduced from peak power by as much as 1 dB or more.

With reference to FIG. 1, in prior art systems, typically an antenna system 100 comprises a transceiver 110 connected, via an orthomode transducer (“OMT”) 120 and a polarizer 130, to a feed horn 140. Feed horn 140 is typically pointed at a microwave reflector 150. Typically, the entire electronics assembly is supported via a boom arm 160. Boom arm 160 is typically attached to the backside of the antenna 150. Antenna 150 may be mounted to a pole that may be connected to a house or other physical structure. The mounting may be accomplished using in any suitable method of attachment.

In the prior art, various mechanical systems and devices have been devised to aid in aligning antenna systems, such as antenna system 100, with an intended satellite 170. For example, a received signal strength meter may be used to align the antenna system with an intended satellite. This method involves the installer adjusting the mechanical pointing of the antenna for maximum received signal strength as measured by the meter. Unfortunately this method suffers from the fact that the installer can only make relatively coarse mechanical adjustments in the antenna position. It also suffers from the fact that the reflector provides a wider beamwidth at the lower receive frequency than it does at the higher transmit frequency. Therefore peaking the beam using the wider receive beamwidth does not necessarily mean that the narrower transmit beam is properly peaked. This method of peaking the receiver signal is also tedious because the antenna must be aligned in both azimuth and elevation planes in an iterative fashion and therefore this process is often not performed correctly by the installer.

Thus, there is a need for new antenna systems and/or methods of aligning those antenna systems. This need includes systems and/or methods that reduce the cost of the antenna system, reduce the complexity or time to install the antenna, are less susceptible to human error, and/or improve the transmit and/or receive performance.

### SUMMARY

In accordance with various aspects of the present invention, a method and system for a phased array illuminated reflector dish RF antenna is presented. In one exemplary embodiment, the phased array illuminated reflector dish RF antenna system includes a phased array connected in communication with one of a transmitter, a receiver, and a transceiver. In an exemplary embodiment, the phased array illuminated reflector dish RF antenna includes a microwave reflector dish. In various exemplary embodiments the phased array illuminated reflector dish RF antenna includes a boom arm supporting the microwave reflector dish and the phased array. In one exemplary embodiment, the phased array only communicates signals with a remote source of the signals via the microwave reflector dish (not directly). In various exemplary embodiments the RF antenna system is configured to be rough pointed by mechanically aiming the RF antenna system, and the RF antenna system is configured to fine tune aim the beam of said RF antenna system by beam steering.

Furthermore, in an exemplary embodiment, a method of aligning an RF transmission antenna system includes rough aiming the antenna, via mechanical methods, approximately at the target. In one embodiment, the antenna is a phased array reflector dish RF antenna system. In various embodiments fine tuning the alignment of the antenna is by beam steering based feedback indicating the quality of the current aiming of the antenna.

In an exemplary embodiment a method for communicating RF signals includes: (1) receiving a transmit signal from a modem at a transmitter, (2) upconverting the transmit signal in the transmitter, (3) transmitting the signal via a transmit portion of a phased array antenna combined with a reflector dish, (4) beam steering to aim the signal of the phased array antenna combined with the reflector dish at a satellite, (5) receiving a receive signal from the satellite, (6) beam steering to aim a receive portion of a phased array antenna combined with a reflector dish, (7) down converting the receive signal from the satellite.

In an exemplary embodiment another method for aligning an RF antenna system includes: (1) rough aiming the RF antenna system, (2) fine tuning the aim of the RF antenna system by electrically beam steering. In one embodiment, the RF antenna system may include a phased array, transceiver, and a reflector dish.

Furthermore, in an exemplary embodiment, a terrestrial microwave communications terminal for aligning an RF antenna system includes a solid state, non-motorized pointing system having fine pointing/automated peaking capability.

Furthermore, in various other exemplary embodiments, a terrestrial microwave communications terminal includes: (1) a phased array connected in communication with one of a transmitter, a receiver, and a transceiver, (2) a microwave reflector dish, (3) a boom arm supporting the phased array and the microwave reflector dish. In an exemplary embodiment, the phased array only communicates signals with a remote source of the signals via the microwave reflector dish, and not directly. In various exemplary embodiments the antenna system is configured to electronically switch polarization of the integrated phased array feed transceiver. In another exemplary embodiment, the terrestrial microwave communications terminal is one of a point to point terminal and a satellite terminal.

### BRIEF DESCRIPTION OF THE DRAWINGS

These and other features, aspects and advantages of the present invention will become better understood with reference to the following description, appending claims, and accompanying drawings where:

FIG. 1 illustrates a side elevation view of a layout of a prior art antenna system;

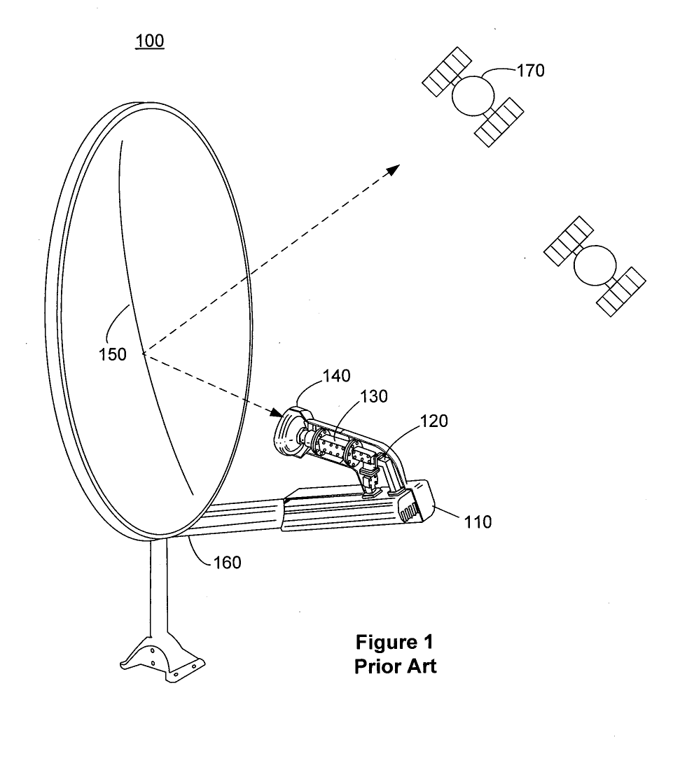

FIG. 2 illustrates an exemplary new antenna system for facilitating antenna alignment;

FIG. 3 is a detailed illustration of various exemplary views of a phased array device;

FIG. 4 is a block diagram of exemplary steps in accordance with an exemplary method;

FIG. 5 depicts various block diagrams useful for discussing multi color switching, in accordance with exemplary embodiments; and

FIGS. 6A-6C illustrate various satellite spot beam color multicolor agility methods in accordance with exemplary embodiments.

### DETAILED DESCRIPTION

In accordance with an exemplary embodiment of the present invention, systems, devices, and methods are provided, for among other things, facilitating improved alignment of satellite antenna systems. The following descriptions are not intended as a limitation on the use or applicability of the invention, but instead, are provided merely to enable a full and complete description of exemplary embodiments.

In accordance with an exemplary embodiment of the present invention, a phased array antenna is combined with a microwave reflector to form an antenna system. In an exemplary embodiment, this antenna system replaces the standard feed structure of a feed horn, an OMT and a polarizer with the phased array. In accordance with various exemplary embodiments, beam steering is used to align the beam from the antenna system with, for example, an intended satellite.

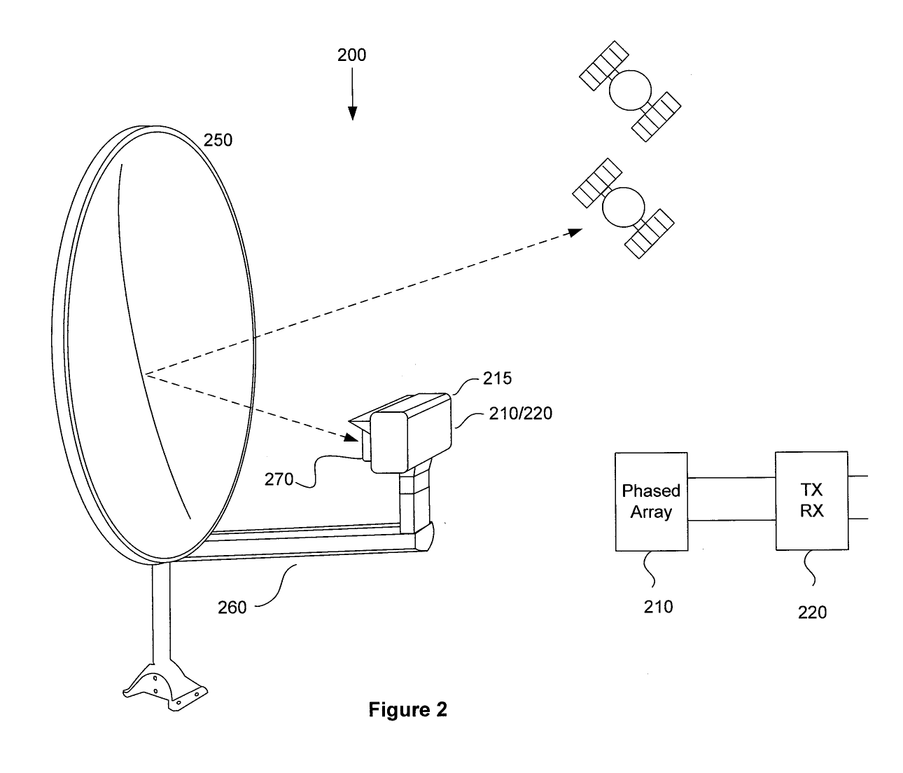

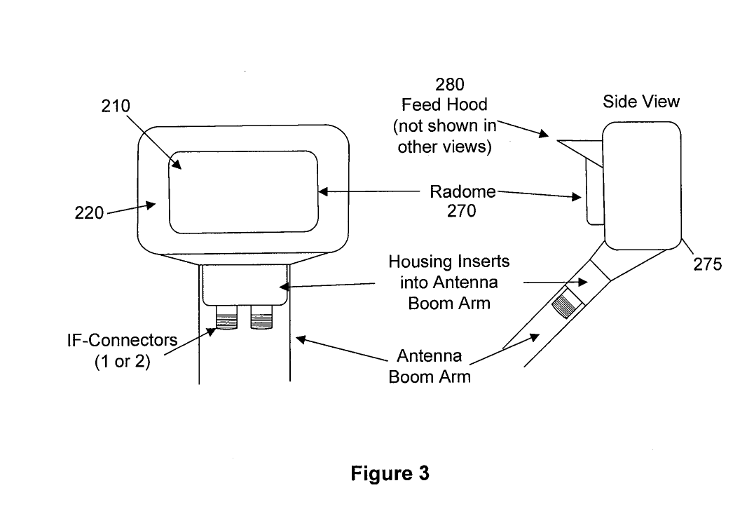

With reference now to FIGS. 2 and 3, in accordance with an exemplary embodiment, an antenna system 200 comprises a phased array 210, a transceiver 220, and a microwave reflector 250. Described another way, in another exemplary embodiment, antenna system 200 comprises an integrated phased array (“IPA”) feed transceiver 215 and microwave reflector 250. IPA feed transceiver 215 comprises phased array 210 and transceiver 220.

In one exemplary embodiment, antenna system 200 further comprises a boom arm 260. The boom arm may, for example support phased array 210, transceiver 220 and microwave reflector 250. In an exemplary embodiment, boom arm 260 is connected on one end to a back support structure (not shown) typically mounted to the back of reflector 250. For example, this back structure may be connected via a pole to a house wall or roof or other physical structure.

Boom arm 260 may be made of any suitable material. For example, metal or plastic. Moreover, any suitable structure may be used for supporting phased array 210, transceiver 220 and microwave reflector 250.

Phased Array 210

In one exemplary embodiment, phased array 210 is connected in signal communication with transceiver 220. Phased array 210 is oriented facing microwave reflector 250. In this way, phased array 210 may be configured to serve as a feed for a standard microwave reflector.

In accordance with an exemplary embodiment, phased array 210 may comprise a phased array transmit. In accordance with another exemplary embodiment, phased array 210 may comprise a phased array receive. In yet another exemplary embodiment, phased array 210 comprises both transmit and receive phased arrays.

In accordance with an exemplary embodiment, phased array 210 may be a planar array of microstrip patches acting as the radiating elements. In accordance with another exemplary embodiment, the phased array(s) may comprise 12-16 elements each. Furthermore, phased array 210 may be any suitable phased array with any suitable number of elements.

As mentioned above, in accordance with an exemplary embodiment, phased array 210 is physically oriented with its boresight direction facing microwave reflector 250. In this regard, precision mounting brackets may be used. Furthermore, any other suitable method for physically orienting phased array 210 to send and/or receive signals by way of microwave reflector 250 may be used.

In accordance with an exemplary embodiment, the phased array is manufactured using techniques and methods described in co-pending U.S. Provisional Application No. 61/222,354, entitled “ACTIVE PHASED ARRAY ARCHITECTURE”, filed Jul. 1, 2009, along with U.S. Provisional Application No. 61/234,521, entitled “MULTI-BAND MULTI-BEAM PHASED ARRAY ARCHITECTURE”, filed Aug. 17, 2009, both of which are incorporated herein in their entirety by reference. For example, the phased array may be made using or incorporate the techniques of: dynamic polarization control, dynamic amplitude control, dynamic phase control, ability to generate multiple independently steerable beams, broadband frequency capability, and low cost implementation. These techniques and/or methods facilitate manufacturing low cost phased arrays and thus the implementation of such arrays in high volume consumer applications such as those described herein.

Transceiver

Transceiver 220 may be connected in signal communication with phased array 210. Transceiver 220 may further comprise a signal input, and/or signal output. The signal input or signal output, in an exemplary embodiment may be connected in signal communication with a modem or the like. The modem, or similar device, may be configured to send and/or receive signals to/from transceiver 220. In one exemplary embodiment, the signal input/output are coaxial cable intermediate frequency connectors. These connectors may be configured for secure attachment to coaxial cable(s) between the modem and transceiver 220. Moreover, any suitable method of providing signals to or receiving signals from transceiver 220 may be used.

Although described herein as a transceiver, it should be understood that wherever applicable through out this description the transceiver may be only a transmitter or only a receiver. Generally, however, transceiver 220 may comprise any typical transceiver components suitable for communication of RF signals. In an exemplary embodiment, the transmit portion of the transceiver may comprise a transmit up-converter, such as a block up-converter (“BUC”). In another exemplary embodiment, the receive portion of the transceiver may comprise a receive down-converter, such as a low noise block (“LNB”) down-converter. Thus, transceiver 220 may comprise any suitable transmitter, receiver, or transceiver components suitable for communication of RF signals in accordance with this disclosure.

In contrast to prior art antenna systems, antenna system 200 does not comprise an orthomode transducer (“OMT”), a polarizer, or a feed horn. These devices are typically mechanical or die-cast formed feed components and are typically found in use in reflector type antennas in consumer broadband internet satellite systems. In an exemplary embodiment, the OMT, polarizer and feed horn components are replaced by a phased array feed.

With further reference to FIG. 3, it is noted that antenna system 200 may further comprise a radome 270. Radome 270 may be configured to cover the phased array(s). For example, a single radome 270 may cover a transmit phased array and/or a receive phased array. In another example, a single radome may cover a transmit phased array and a second radome may cover a receive phased array. In any event, the radome(s) are configured to protect the phased array(s) from environmental conditions such as debris or rain.

Antenna system 200 may further comprise a transceiver housing 275. Transceiver housing 275 may enclose or partially enclose a transmitter, receiver, or transceiver. Transceiver housing may further support phased array 210. Transceiver housing may further support radome 270. Transceiver housing 275 may be made of metal, plastic, or any suitable material.

Antenna system 200 may further comprise a feed rain hood 280. Feed rain hood 280 may be located over radome 270. Feed rain hood 280 may be supported by transceiver housing 275. Feed rain hood 280 may be any suitable configuration for protecting the radome and/or the phased array from rain and the like. In another exemplary embodiment, the housing may be configured to insert into the antenna boom arm. In this exemplary embodiment, the IF connector(s) may also be positioned to be within the boom arm. This exemplary embodiment may provide protection to the connection point between the cable feed to the modem and the transceiver.

Although various exemplary frequencies are disclosed herein, the invention is not necessarily limited to specific frequencies. Nor is the invention limited to specific antenna sizes. That said, the antenna system described herein may be most useful in high gain antenna applications. This is because high gain antenna applications involve a narrow beam. The narrow beam tends to increase the importance of accurate aiming of the beam from the antenna system.

Most satellite communication systems require high gain antennas. Furthermore, as the need for increasing bandwidths necessitate operating at higher carrier frequencies, in an exemplary embodiment the transceiver is a high frequency consumer broadband transceiver. In an exemplary embodiment, the transceiver may transmit on the Ka frequency. For example, the transceiver may transmit over the 27.5-31 GHz range, while receiving over the 17.7-21.2 GHz range. In another exemplary embodiment, the transceiver may be configured for broadband Internet services delivered using satellites orbiting in geo-stationary orbits. In another exemplary embodiment, the transceiver is configured to be used in Very Small Aperture Terminal (VSAT) applications or in consumer satellite ground terminal applications.

Point to Point or Satellite.

Although described herein in the context of ground to satellite communications, it should be appreciated that the teachings of this disclosure are equally applicable in the context of terrestrial applications. For example, the antenna system and methods of the present disclosure are equally applicable to fixed wireless access terminals. One example of this is Local Multipoint Distribution Service (LMDS) systems operating at mm wave frequency. As another example, the teachings of this disclosure are equally applicable in the context of any wireless point to point microwave systems. For example, the antenna system may be configured to be used in wireless point-to-point systems that are used between cell towers and can operate at E-Band frequencies as high as 70-86 GHz where pointing may become very difficult even for small antennas.

In an exemplary embodiment, antenna system 200 is physically aimed or pointed in a direction that is close to a desired direction. For example, antenna system 200 may be physically aimed to within an accuracy of plus or minus ½ percent of the desired direction, plus or minus 1 percent of the desired direction, or the like.

In accordance with an exemplary embodiment, after initial physical aiming of antenna system 200, the aim of the beam from antenna system 200 is steered to fine tune the beam aim. Thus, in an exemplary embodiment, antenna system 200 is configured to steer the direction of the beam. The beam steering may occur without any physical movement of antenna system 200.

In accordance with an exemplary embodiment, the beam is steered from its original position no greater than 3 degrees. In other exemplary embodiments, the beam is steered from its original position no greater than 1 degree. In other exemplary embodiments, the beam is steered from its original position no greater than ½ degree. Moreover, in an exemplary embodiment the beam may be steered from its original position any suitable amount possible.

In accordance with an exemplary embodiment, the beam is steered in an automated manner. In an exemplary embodiment, the final or fine tuning alignment is performed without physical movement of the antenna system. The automated beam steering may facilitate preventing or reducing the chance of antenna beam mis-alignment.

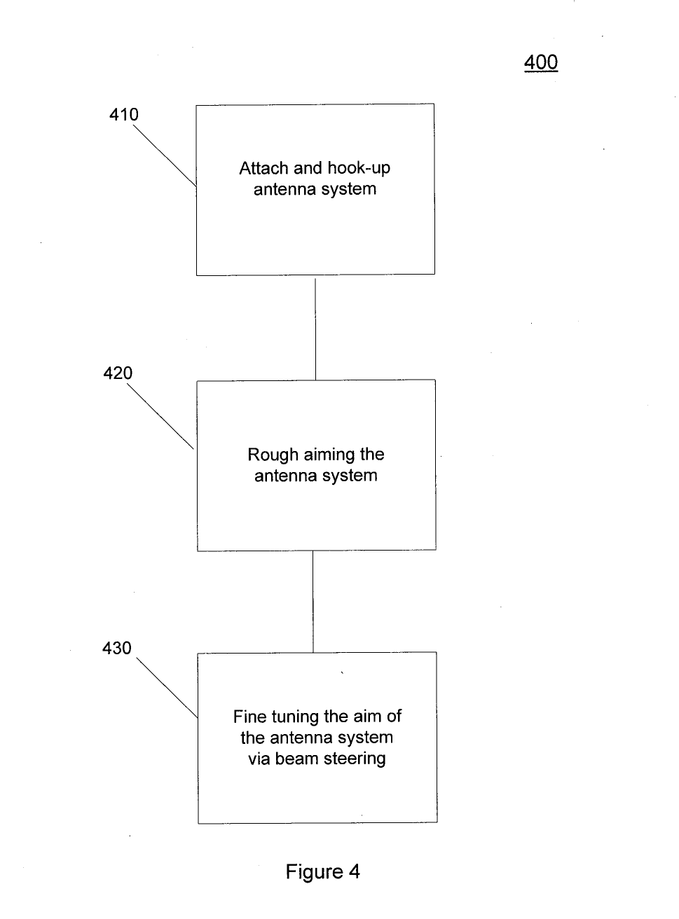

Turning now to FIG. 4, in accordance with an exemplary embodiment, a method 400 is described for facilitating improved aiming of the beam from antenna system 200. In new installation embodiments, for example, method 400 may comprise attaching and hooking up the antenna system (step 410). This step may comprise many steps that are similar to the installation of prior art feed horn antenna systems. By way of example, the antenna system may be attached to a structure (such as a building), and cable(s) may be attached to the transceiver. This step may further involve assembling the various components of the antenna system.

Method 400 may further comprise rough aiming the antenna system at an intended target (step 420). For example, the antenna system may be pointed approximately at a satellite or terrestrial target. The rough aiming step may be effectuated using any suitable technique that makes it possible for the subsequent fine tuning step to work. For example, the antenna system may be pointed by physically moving the antenna in the azimuth and elevation planes, in an iterative fashion, while measuring the signal strength of the received signal. The iterative physical movement and measuring is performed in manner that maximizes the signal strength.

In accordance with an exemplary embodiment, method 400 further comprises fine tuning the aim of the antenna system (step 430). The fine tuning is implemented by using beam steering with the phased array. In an exemplary embodiment, steering of the phased array is done electronically. Thus, the steering can be very precisely controlled using digital control of phase shifters on an element by element basis.

In an exemplary embodiment, the beam steering is performed by electronically steering the beam in both the azimuth and elevation planes, in an iterative fashion, while measuring the signal strength of the received signal and steering the beam to maximize the received signal strength. In accordance with one aspect of an exemplary embodiment, this beam steering method is much more precise than prior art methods of physically pointing the antenna. Moreover, this beam steering method facilitates eliminating the loss of signal due to mechanical alignment during installation and also due to any subsequent movement of the antenna such as may be caused by excessive wind or snow loading.

In one exemplary embodiment, the transmit and receive phased arrays are independently pointed. This facilitates elimination or at least reduction of performance losses due to beam squint commonly found on focal feed reflector antenna systems using orthogonal transmit and receive polarization commonly found in satellite ground terminals.

In another exemplary embodiment, the transmit and receive phase centers are co-located. In another exemplary embodiment, phased array 210 comprises two or more frequency bands with interleaved waveguide apertures and radiating elements.

Additional aspects of phased arrays for use with the present invention are disclosed in a co-pending U.S. Patent Application entitled “DUAL-POLARIZED, MULTI-BAND, FULL-DUPLEX, INTERLEAVED WAVEGUIDE APERTURE,” having the same filing date as the present application, the contents of which are hereby incorporated by reference in their entirety.

In one exemplary embodiment, the beam steering is controlled based upon signal strength feedback. The signal strength feedback may include information relative to the current aim of the beam and/or any mis-alignment of the beam. Furthermore, beam steering may be based on any suitable indication of the signal strength or quality including, but not limited to: bit error rate (BER), signal to noise ratio (SNR), received signal strength (RSS), beacon pointing, signal-to-interference ratio (SIR), signal-to-interference noise ratio (SINR), frame error rate (FER), cyclic redundancy check (CRC), and/or the like.

In an exemplary embodiment the signal strength feedback includes information related to the magnitude of the degrees the antenna beam signal is mis-aligned. In another exemplary embodiment, the feedback includes information related to the received signal strength. The antenna system is configured to steer the beam based on the signal strength feedback until it is pointed in the desired direction. The desired direction may, for example, be the direction of maximum received signal strength.

The fine tuning may be carried out in an automated manner. Various algorithms and/or devices may be used to facilitate antenna system 200 in steering the beam to the desired direction. In an exemplary embodiment, beam steering may involve looking for maximum receive signal strength for the receive signal, and/or maximum transmit signal strength for the transmitter. It is noted that looking for maximum transmit signal strength for the transmitter may involve communication to a central hub or gateway which then measures the transmit signal that it receives from the user terminal. This measured value can then be reported back to the user terminal for facilitating a determination of the maximum transmit signal strength.

In an exemplary embodiment, once the beam has been steered in the desired direction, the beam may be kept steered in this direction. In further exemplary embodiments, however, antenna system 200 may be configured to re-adjust the beam steering, when appropriate. Stated differently, antenna system 200 may be configured to re-peak in an automated fashion throughout the life of the terminal. This re-adjusting may occur periodically, continuously, or upon external prompt. This may facilitate maintaining high performance throughout the life of the antenna system. In particular, this may allow for changes which occur over time such as a building settling, bolts loosening, material deformation, movement of the target (e.g., satellite drift), wind, and/or the like.

In this manner, an individual or a help desk could re-aim the beam of the antenna system to improve performance. The individual might initiate the re-aiming of the beam of the antenna by merely pressing a button on the antenna system or the modem or by requesting the re-aiming through a computer interface. Similarly, the re-aiming might be remotely initiated by product support, either live or automated product support. For example, a product support help desk might initiate re-aiming in response to a customer complaint about antenna system performance.

In another exemplary embodiment, the antenna system may be configured to report to product support on a regular basis and beam steering implemented when appropriate. This may be particularly useful for improving system performance if a number of antenna systems on one satellite become slightly mis-aligned. For example, if strong winds, an earth quake, or other random disturbances result in a large number of antenna systems becoming slightly out of alignment, the ability to remotely re-align each of these antenna systems can improve the entire system performance. Moreover, in accordance with an exemplary embodiment, the antenna system is configured to facilitate re-peaking without a human touching the antenna system. In particular, the antenna system may be configured to facilitate re-peaking without sending out a service truck. This provides considerable savings in time and expense.

Thus, in accordance with various aspects of exemplary embodiments of the present invention, the time and/or cost of installing antenna systems may be reduced. Similarly, the skill and training for installing antenna systems and or maintaining those systems may be reduced. In fact, in some exemplary embodiments the ability to fine tune aim in an automated manner may facilitate installation by customers themselves. This may further reduce the cost of commercializing antenna systems.

In this industry, great effort and expense is often employed in improving the power of the transmission within certain constraints. Unfortunately, if the antenna system is not pointed properly, by just a small amount, the power loss can exceed any power gains achieved at such a cost. In various exemplary embodiments, the chance of losing power due to mis-aiming is reduced. Similarly, the ability to use less costly transceivers may be facilitated because mis-alignment power loss is less likely.

In accordance with various exemplary embodiments, the automated beam steering is configured to optimize pointing the beam. The automated beam steering may be configured to optimize product performance. This may be described, in comparison to an antenna system not using phased array beam steering, as: reducing satellite link interference; reducing off-axis interference into other satellites; reducing transmission interference; optimizing transmit and receive performance; improving reception; and/or reducing transmission interference.

In various exemplary embodiments, across a large group of antenna systems, improving aiming of the beam of the individual antenna systems is configured to maximize link availability, improve service quality, and/or increase satellite channel capacity (more users per channel), in comparison to an antenna system not using phased array beam steering.

It is noted that in comparison to an antenna system not using array beam steering, array beam steering may improve the quality of the communication signal for the subscriber or provide the same quality level but for more subscribers. Furthermore, in comparison to an antenna system not using array beam steering, array beam steering may improve the power of the communication signal.

Automated pointing, via beam steering, of antenna systems, may facilitate widespread use of higher frequencies (narrower bandwidths) for future systems. For example, use of frequencies of 40-50 GHz or higher where beam widths for even small aperture antennas (less than 1 m) would be too narrow for even professional installers to align well.

Electronic Switching of Polarization

In accordance with an exemplary embodiment, antenna system 200 is configured to facilitate electronic switching of polarization. For example, antenna system 200 may be configured to facilitate electronic switching of polarization between left and right hand circular. In another exemplary embodiment, antenna system 200 is configured to facilitate electronic switching of polarization between horizontal linear and vertical linear. In other exemplary embodiments, antenna system 200 may be configured to facilitate electronic alignment of linear polarization.

Such electronic switching or alignment of polarization may be facilitated through use of appropriate phase delay(s). In various exemplary embodiments, antenna system 200 is configured to move a customer from one polarization to another. This may occur in an electronic and automated manner. In one exemplary embodiment, antenna system 200 is configured to be remotely controlled to switch from one polarization to another. In other exemplary embodiments, a mechanical device and/or manual methods may be used to move a customer from one polarization to another.

The ability to electronically switch from one polarization to another facilitates optimizing the utilization factors on the RF channels. In the prior art, if one wished to change a transceiver polarization, for example from left hand linear polarization to right hand linear polarization, it would require a technician to physically disassemble the polarizer and attach it rotated from its previous position. Clearly this could not be done with much frequency and only a limited number (on the order of 10 or maybe 20) of transceivers could be switched per technician in a day. Although electromechanical methods of switching polarization, described in co-pending provisional application having Ser. No. 61/259,053 entitled “ELECTROMECHANICAL POLARIZATION SWITCH,” filed Nov. 6, 2009, the contents of which are hereby incorporated by reference in their entirety, alleviate some of these concerns, such systems may be limited in the number of times they can switch polarization due to their mechanical components.

In accordance with an exemplary embodiment, antenna system 200 is configured to switch polarization electronically. For example, antenna system 200 may be configured to perform dynamic load leveling by electronic polarization switching. In an exemplary embodiment, the switching may occur with any frequency. For example, the polarization may be switched during the evening hours, and then switched back during business hours to reflect transmission load variations that occur over time. In an exemplary embodiment, the polarization switching occurs instantaneously or nearly instantaneously. Thus, a large number of antenna systems communicating with a single satellite, for example, can be actively managed in real time to account for variations in usage across the entire group of antenna systems, causing load variations.

In an exemplary embodiment, the polarization switching is initiated from a remote location. For example, a central system may determine that load changes have significantly slowed down the left hand polarized channel, but that the right hand polarized channel has available bandwidth. The central system could then remotely switch the polarization of a number of antenna systems (in this example, from left to right hand polarization). This would improve channel availability for switched and non-switched users alike.

Multi-Color System:

In the field of consumer satellite RF communication, a satellite will typically transmit and/or receive data (e.g., movies and other television programming, internet data, and/or the like) to consumers who have personal satellite dishes at their home. More recently, the satellites may transmit/receive data from more mobile platforms (such as, transceivers attached to airplanes, trains, and/or automobiles). It is anticipated that increased use of handheld or portable satellite transceivers will be the norm in the future. Although sometimes described in this document in connection with home satellite transceivers, the prior art limitations now discussed may be applicable to any personal consumer terrestrial transceivers (or transmitters or receivers) that communicate with a satellite.

A propagating radio frequency (RF) signal can have different polarizations, namely linear, elliptical, or circular. Linear polarization consists of vertical polarization and horizontal polarization, whereas circular polarization consists of left-hand circular polarization (LHCP) and right-hand circular polarization (RHCP). An antenna is typically configured to pass one polarization, such as LHCP, and reject the other polarization, such as RHCP.

Also, conventional very small aperture terminal (VSAT) antennas utilize a fixed polarization that is hardware dependant. The basis polarization is generally set during installation of the satellite terminal, at which point the manual configuration of the polarizer hardware is fixed. For example, a polarizer is generally set for LHCP or RHCP and fastened into position. To change polarization in a conventional VSAT antenna might require unfastening the polarizer, rotating it 90 degrees to the opposite circular polarization, and then refastening the polarizer. Clearly this could not be done with much frequency and only a limited number (on the order of 5 or maybe 10) of transceivers could be switched per technician in a given day.

Unlike a typical single polarization antenna, some devices are configured to change polarizations without disassembling the antenna terminal. As an example, a prior embodiment is the use of “baseball” switches to provide electronically commandable switching between polarizations. The rotation of the “baseball” switches causes a change in polarization by connecting one signal path and terminating the other signal path. However, each “baseball” switch requires a separate rotational actuator with independent control circuitry, which increases the cost of device such that this configuration is not used (if at all) in consumer broadband or VSAT terminals, but is instead used for large ground stations with a limited number of terminals.

Furthermore, another approach is to have a system with duplicate hardware for each polarization. The polarization selection is achieved by completing or enabling the path of the desired signal and deselecting the undesired signal. This approach is often used in receive-only terminals, for example satellite television receivers having low-cost hardware. However, with two way terminals that both transmit and receive such as VSAT or broadband terminals, doubling the hardware greatly increases the cost of the terminal.

Conventional satellites may communicate with the terrestrial based transceivers via radio frequency signals at a particular frequency band and a particular polarization. Each combination of a frequency band and polarization is known as a “color”. The satellite will transmit to a local geographic area with signals in a “beam” and the geographic area that can access signals on that beam may be represented by “spots” on a map. Each beam/spot will have an associated “color.” Thus, beams of different colors will not have the same frequency, the same polarization, or both.

In practice, there is some overlap between adjacent spots, such that at any particular point there may be two, three, or more beams that are “visible” to any one terrestrial transceiver. Adjacent spots will typically have different “colors” to reduce noise/interference from adjacent beams.

In the prior art, broadband consumer satellite transceivers are typically set to one color and left at that setting for the life of the transceiver. Should the color of the signal transmitted from the satellite be changed, all of the terrestrial transceivers that were communicating with that satellite on that color would be immediately stranded or cut off. Typically, a technician would have to visit the consumer's home and manually change out (or possibly physically disassemble and re-assemble) the transceiver or polarizer to make the consumer's terrestrial transceiver once again be able to communicate with the satellite on the new “color” signal. The practical effect of this is that in the prior art, no changes are made to the signal color transmitted from the satellite.

For similar reasons, a second practical limitation is that terrestrial transceivers are typically not changed from one color to another (i.e. if they are changed, it is a manual process). Thus, there is a need for a new low cost method and device to remotely change the frequency and/or polarization of an antenna system. There is also a need for a method and device that may be changed nearly instantaneously and often.

In spot beam communication satellite systems, both frequency and polarization diversity are utilized to reduce interference from adjacent spot beams. In an exemplary embodiment, both frequencies and polarizations are re-used in other beams that are geographically separated to maximize communications traffic capacity. The spot beam patterns are generally identified on a map using different colors to identify the combination of frequency and polarity used in that spot beam. The frequency and polarity re-use pattern is then defined by how many different combinations (or “colors”) are used.

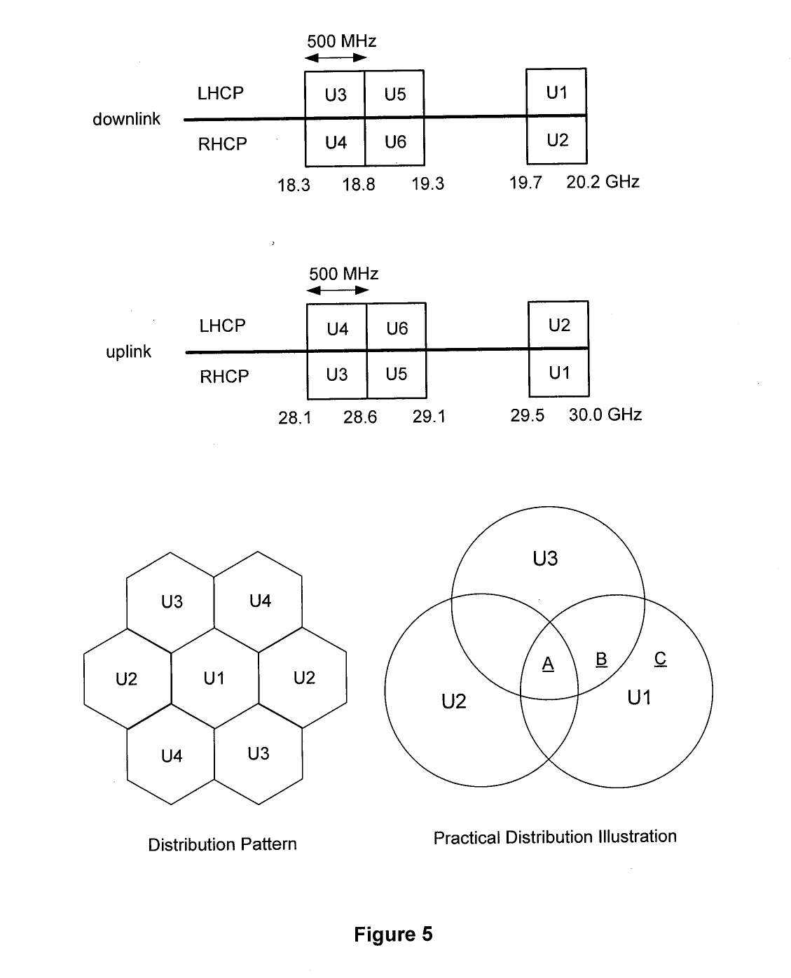

In accordance with various exemplary embodiments and with reference to FIG. 5, an antenna system is configured for frequency and polarization switching. In one specific exemplary embodiment, the frequency and polarization switching comprises switching between two frequency ranges and between two different polarizations. This may be known as four color switching. In other exemplary embodiments, the frequency and polarization switching comprises switching between three frequency ranges and between two different polarizations, for a total of six separate colors. Furthermore, in various exemplary embodiments, the frequency and polarization switching may comprise switching between two polarizations with any suitable number of frequency ranges. In another exemplary embodiment, the frequency and polarization switching may comprise switching between more than two polarizations with any suitable number of frequency ranges.

In accordance with various exemplary embodiments, the ability to perform frequency and polarization switching has many benefits in terrestrial microwave communications terminals. For example, doing so may facilitate increased bandwidth, load shifting, roaming, increased data rate/download speeds, improved overall efficiency of a group of users on the system, or improved individual data communication rates. Terrestrial microwave communications terminals, in one exemplary embodiment, comprise point to point terminals. In another exemplary embodiment, terrestrial microwave communications terminals comprise ground terminals for use in communication with any satellite, such as a satellite configured to switch frequency range and/or polarity of a RF signal broadcasted. These terrestrial microwave communications terminals are spot beam based systems.

In accordance with various exemplary embodiments, a satellite configured to communicate one or more RF signal beams each associated with a spot and/or color has many benefits in microwave communications systems. For example, similar to what was stated above for exemplary terminals in accordance with various embodiments, doing so may facilitate increased bandwidth, load shifting, roaming, increased data rate/download speeds, improved overall efficiency of a group of users on the system, or improved individual data communication rates. In accordance with another exemplary embodiment, the satellite is configured to remotely switch frequency range and/or polarity of a RF signal broadcasted by the satellite. This has many benefits in microwave communications systems. In another exemplary embodiment, satellites are in communications with any suitable terrestrial microwave communications terminal, such as a terminal having the ability to perform frequency and/or polarization switching.

Prior art spot beam based systems use frequency and polarization diversity to reduce or eliminate interference from adjacent spot beams. This allows frequency reuse in non-adjacent beams resulting in increased satellite capacity and throughput. Unfortunately, in the prior art, in order to have such diversity, installers of such systems must be able to set the correct polarity at installation or carry different polarity versions of the terminal. For example, at an installation site, an installer might carry a first terminal configured for left hand polarization and a second terminal configured for right hand polarization and use the first terminal in one geographic area and the second terminal in another geographic area. Alternatively, the installer might be able to disassemble and reassemble a terminal to switch it from one polarization to another polarization. This might be done, for example, by removing the polarizer, rotating it 90 degrees, and reinstalling the polarizer in this new orientation. These prior art solutions are cumbersome in that it is not desirable to have to carry a variety of components at the installation site. Also, the manual disassembly/reassembly steps introduce the possibility of human error and/or defects.

These prior art solutions, moreover, for all practical purposes, permanently set the frequency range and polarization for a particular terminal. This is so because any change to the frequency range and polarization will involve the time and expense of a service call. An installer would have to visit the physical location and change the polarization either by using the disassembly/re-assembly technique or by just switching out the entire terminal. In the consumer broadband satellite terminal market, the cost of the service call can exceed the cost of the equipment and in general manually changing polarity in such terminals is economically unfeasible.

In accordance with various exemplary embodiments, a low cost system and method for electronically or electro-mechanically switching frequency ranges and/or polarity is provided. In an exemplary embodiment, the frequency range and/or polarization of a terminal can be changed without a human touching the terminal. Stated another way, the frequency range and/or polarization of a terminal can be changed without a service call. In an exemplary embodiment, the system is configured to remotely cause the frequency range and/or polarity of the terminal to change.

In one exemplary embodiment, the system and method facilitate installing a single type of terminal that is capable of being electronically set to a desired frequency range from among two or more frequency ranges. Some exemplary frequency ranges include receiving 10.7 GHz to 12.75 GHz, transmitting 13.75 GHz to 14.5 GHz, receiving 18.3 GHz to 20.2 GHz, and transmitting 28.1 GHz to 30.0 GHz. Furthermore, other desired frequency ranges of a point-to-point system fall within 15 GHz to 38 GHz. In another exemplary embodiment, the system and method facilitate installing a single type of terminal that is capable of being electronically set to a desired polarity from among two or more polarities. The polarities may comprise, for example, left hand circular, right hand circular, vertical linear, horizontal linear, or any other orthogonal polarization. Moreover, in various exemplary embodiments, a single type of terminal may be installed that is capable of electronically selecting both the frequency range and the polarity of the terminal from among choices of frequency range and polarity, respectively.

In an exemplary embodiment, transmit and receive signals are paired so that a common switching mechanism switches both signals simultaneously. For example, one “color” may be a receive signal in the frequency range of 19.7 GHz to 20.2 GHz using RHCP, and a transmit signal in the frequency range of 29.5 GHz to 30.0 GHz using LHCP. Another “color” may use the same frequency ranges but transmit using RHCP and receive using LHCP. Accordingly, in an exemplary embodiment, transmit and receive signals are operated at opposite polarizations. However, in some exemplary embodiments, transmit and receive signals are operated on the same polarization which increases the signal isolation requirements for self-interference free operation.

Thus, a single terminal type may be installed that can be configured in a first manner for a first geographical area and in a second manner for a second geographical area that is different from the first area, where the first geographical area uses a first color and the second geographical area uses a second color different from the first color.

In accordance with an exemplary embodiment, a terminal, such as a terrestrial microwave communications terminal, may be configured to facilitate load balancing. In accordance with another exemplary embodiment, a satellite may be configured to facilitate load balancing. Load balancing involves moving some of the load on a particular satellite, or point-to-point system, from one polarity/frequency range “color” or “beam” to another. In an exemplary embodiment, the load balancing is enabled by the ability to remotely switch frequency range and/or polarity of either the terminal or the satellite.

Thus, in exemplary embodiments, a method of load balancing comprises the steps of remotely switching frequency range and/or polarity of one or more terrestrial microwave communications terminals. For example, system operators or load monitoring computers may determine that dynamic changes in system bandwidth resources has created a situation where it would be advantageous to move certain users to adjacent beams that may be less congested. In one example, those users may be moved back at a later time as the loading changes again. In an exemplary embodiment, this signal switching (and therefore this satellite capacity “load balancing”) can be performed periodically. In other exemplary embodiments, load balancing can be performed on many terminals (e.g., hundreds or thousands of terminals) simultaneously or substantially simultaneously. In other exemplary embodiments, load balancing can be performed on many terminals without the need for thousands of user terminals to be manually reconfigured.

In one exemplary embodiment, dynamic control of signal polarization is implemented for secure communications by utilizing polarization hopping. Communication security can be enhanced by changing the polarization of a communications signal at a rate known to other authorized users. An unauthorized user will not know the correct polarization for any given instant and if using a constant polarization, the unauthorized user would only have the correct polarization for brief instances in time. A similar application to polarization hopping for secure communications is to use polarization hopping for signal scanning. In other words, the polarization of the antenna can be continuously adjusted to monitor for signal detection.

In an exemplary embodiment, the load balancing is performed as frequently as necessary based on system loading. For example, load balancing could be done on a seasonal basis. For example, loads may change significantly when schools, colleges, and the like start and end their sessions. As another example, vacation seasons may give rise to significant load variations. For example, a particular geographic area may have a very high load of data traffic. This may be due to a higher than average population density in that area, a higher than average number of transceivers in that area, or a higher than average usage of data transmission in that area. In another example, load balancing is performed on an hourly basis. Furthermore, load balancing could be performed at any suitable time. In one example, if maximum usage is between 6-7 PM then some of the users in the heaviest loaded beam areas could be switched to adjacent beams in a different time zone. In another example, if a geographic area comprises both office and home terminals, and the office terminals experience heaviest loads at different times than the home terminals, the load balancing may be performed between home and office terminals. In yet another embodiment, a particular area may have increased localized signal transmission traffic, such as related to high traffic within businesses, scientific research activities, graphic/video intensive entertainment data transmissions, a sporting event or a convention. Stated another way, in an exemplary embodiment, load balancing may be performed by switching the color of any subgroup(s) of a group of transceivers.

In an exemplary embodiment, the consumer broadband terrestrial terminal is configured to determine, based on preprogrammed instructions, what colors are available and switch to another color of operation. For example, the terrestrial terminal may have visibility to two or more beams (each of a different color). The terrestrial terminal may determine which of the two or more beams is better to connect to. This determination may be made based on any suitable factor. In one exemplary embodiment, the determination of which color to use is based on the data rate, the download speed, and/or the capacity on the beam associated with that color. In other exemplary embodiments, the determination is made randomly, or in any other suitable way.

This technique is useful in a geographically stationary embodiment because loads change over both short and long periods of time for a variety of reasons and such self adjusting of color selection facilitates load balancing. This technique is also useful in mobile satellite communication as a form of “roaming”. For example, in one exemplary embodiment, the broadband terrestrial terminal is configured to switch to another color of operation based on signal strength. This is, in contrast to traditional cell phone type roaming, where that roaming determination is based on signal strength. In contrast, here, the color distribution is based on capacity in the channel. Thus, in an exemplary embodiment, the determination of which color to use may be made to optimize communication speed as the terminal moves from one spot to another. Alternatively, in an exemplary embodiment, a color signal broadcast by the satellite may change or the spot beam may be moved and still, the broadband terrestrial terminal may be configured to automatically adjust to communicate on a different color (based, for example, on channel capacity).

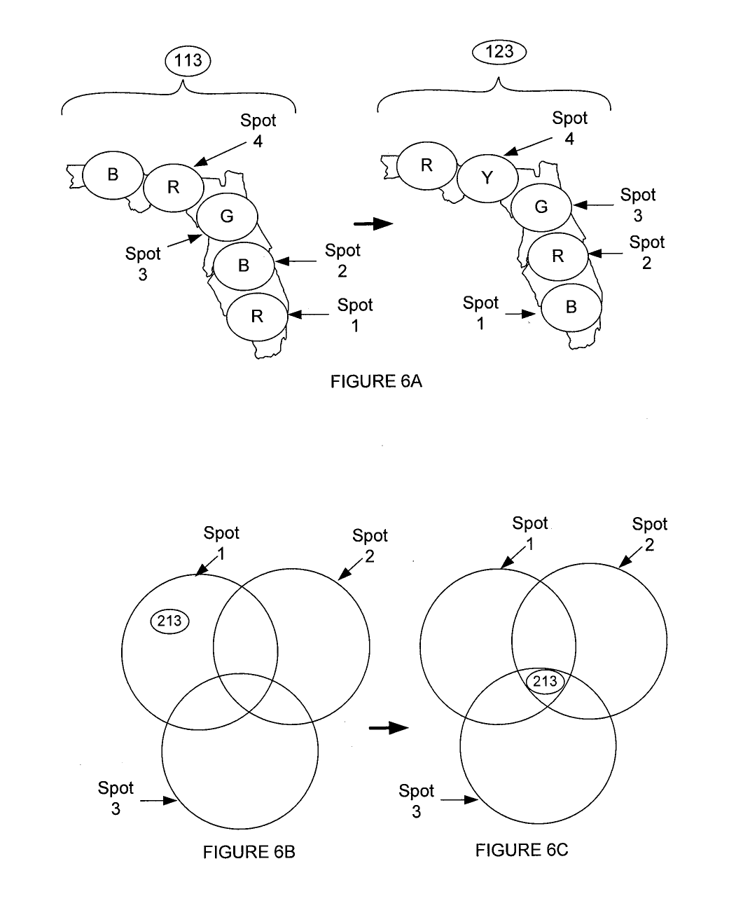

In accordance with another exemplary embodiment, a satellite is configured to communicate one or more RF signal beams each associated with a spot and/or color. In accordance with another exemplary embodiment, the satellite is configured to remotely switch frequency range and/or polarity of a RF signal broadcasted by the satellite. In another exemplary embodiment, a satellite may be configured to broadcast additional colors. For example, an area and/or a satellite might only have 4 colors at a first time, but two additional colors, (making 6 total colors) might be dynamically added at a second time. In this event, it may be desirable to change the color of a particular spot to one of the new colors. With reference to FIG. 6A, spot 4 changes from “red” to then new color “yellow”. In one exemplary embodiment, the ability to add colors may be a function of the system's ability to operate, both transmit and/or receive over a wide bandwidth within one device and to tune the frequency of that device over that wide bandwidth.

In accordance with an exemplary embodiment, and with renewed reference to FIG. 5, a satellite may have a downlink, an uplink, and a coverage area. The coverage area may be comprised of smaller regions each corresponding to a spot beam to illuminate the respective region. Spot beams may be adjacent to one another and have overlapping regions. A satellite communications system has many parameters to work: (1) number of orthogonal time or frequency slots (defined as color patterns hereafter); (2) beam spacing (characterized by the beam roll-off at the cross-over point); (3) frequency re-use patterns (the re-use patterns can be regular in structures, where a uniformly distributed capacity is required); and (4) numbers of beams (a satellite with more beams will provide more system flexibility and better bandwidth efficiency). Polarization may be used as a quantity to define a re-use pattern in addition to time or frequency slots. In one exemplary embodiment, the spot beams may comprise a first spot beam and a second spot beam. The first spot beam may illuminate a first region within a geographic area, in order to send information to a first plurality of subscriber terminals. The second spot beam may illuminate a second region within the geographic area and adjacent to the first region, in order to send information to a second plurality of subscriber terminals. The first and second regions may overlap.

The first spot beam may have a first characteristic polarization. The second spot beam may have a second characteristic polarization that is orthogonal to the first polarization. The polarization orthogonality serves to provide an isolation quantity between adjacent beams. Polarization may be combined with frequency slots to achieve a higher degree of isolation between adjacent beams and their respective coverage areas. The subscriber terminals in the first beam may have a polarization that matches the first characteristic polarization. The subscriber terminals in the second beam may have a polarization that matches the second characteristic polarization.

The subscriber terminals in the overlap region of the adjacent beams may be optionally assigned to the first beam or to the second beam. This optional assignment is a flexibility within the satellite system and may be altered through reassignment following the start of service for any subscriber terminals within the overlapping region. The ability to remotely change the polarization of a subscriber terminal in an overlapping region illuminated by adjacent spot beams is an important improvement in the operation and optimization of the use of the satellite resources for changing subscriber distributions and quantities. For example it may be an efficient use of satellite resources and improvement to the individual subscriber service to reassign a user or a group of users from a first beam to a second beam or from a second beam to a first beam. Satellite systems using polarization as a quantity to provide isolation between adjacent beams may thus be configured to change the polarization remotely by sending a signal containing a command to switch or change the polarization from a first polarization state to a second orthogonal polarization state. The intentional changing of the polarization may facilitate reassignment to an adjacent beam in a spot beam satellite system using polarization for increasing a beam isolation quantity.

The down link may comprise multiple “colors” based on combinations of selected frequency and/or polarizations. Although other frequencies and frequency ranges may be used, and other polarizations as well, an example is provided of one multicolor embodiment. For example, and with renewed reference to FIG. 5, in the downlink, colors U1, U3, and U5 are Left-Hand Circular Polarized (“LHCP”) and colors U2, U4, and U6 are Right-Hand Circular Polarized (“RHCP”). In the frequency domain, colors U3 and U4 are from 18.3-18.8 GHz; U5 and U6 are from 18.8-19.3 GHz; and U1 and U2 are from 19.7-20.2 GHz. It will be noted that in this exemplary embodiment, each color represents a 500 MHz frequency range. Other frequency ranges may be used in other exemplary embodiments. Thus, selecting one of LHCP or RHCP and designating a frequency band from among the options available will specify a color. Similarly, the uplink comprises frequency/polarization combinations that can be each designated as a color. Often, the LHCP and RHCP are reversed as illustrated, providing increased signal isolation, but this is not necessary. In the uplink, colors U1, U3, and U5 are RHCP and colors U2, U4, and U6 are LHCP. In the frequency domain, colors U3 and U4 are from 28.1-28.6 GHz; U5 and U6 are from 28.6-29.1 GHz; and U1 and U2 are from 29.5-30.0 GHz. It will be noted that in this exemplary embodiment, each color similarly represents a 500 MHz frequency range.

In an exemplary embodiment, the satellite may broadcast one or more RF signal beam (spot beam) associated with a spot and a color. This satellite is further configured to change the color of the spot from a first color to a second, different, color. Thus, with renewed reference to FIG. 6A, spot 1 is changed from “red” to “blue”.

When the color of one spot is changed, it may be desirable to change the colors of adjacent spots as well. Again with reference to FIG. 6A, the map shows a group of spot colors at a first point in time, where this group at this time is designated 113, and a copy of the map shows a group of spot colors at a second point in time, designated 123. Some or all of the colors may change between the first point in time and the second point in time. For example spot 1 changes from red to blue and spot 2 changes from blue to red. Spot 3, however, stays the same. In this manner, in an exemplary embodiment, adjacent spots are not identical colors.

Some of the spot beams are of one color and others are of a different color. For signal separation, the spot beams of similar color are typically not located adjacent to each other. In an exemplary embodiment, and with reference again to FIG. 5, the distribution pattern illustrated provides one exemplary layout pattern for four color spot beam frequency re-use. It should be recognized that with this pattern, color U1 will not be next to another color U1, etc. It should be noted, however, that typically the spot beams will over lap and that the spot beams may be better represented with circular areas of coverage. Furthermore, it should be appreciated that the strength of the signal may decrease with distance from the center of the circle, so that the circle is only an approximation of the coverage of the particular spot beam. The circular areas of coverage may be overlaid on a map to determine what spot beam(s) are available in a particular area.

In accordance with an exemplary embodiment, the satellite is configured to shift one or more spots from a first geographic location to a second geographic location. This may be described as shifting the center of the spot from a first location to a second location. This might also be described as changing the effective size (e.g. diameter) of the spot. In accordance with an exemplary embodiment, the satellite is configured to shift the center of the spot from a first location to a second location and/or change the effective size of one or more spots. In the prior art, it would be unthinkable to shift a spot because such an action would strand terrestrial transceivers. The terrestrial transceivers would be stranded because the shifting of one or more spots would leave some terrestrial terminals unable to communicate with a new spot of a different color.

However, in an exemplary embodiment, the transceivers are configured to easily switch colors. Thus, in an exemplary method, the geographic location of one or more spots is shifted and the color of the terrestrial transceivers may be adjusted as needed.

In an exemplary embodiment, the spots are shifted such that a high load geographic region is covered by two or more overlapping spots. For example, with reference to FIGS. 6B and 6C, a particular geographic area 213 may have a very high load of data traffic. In this exemplary embodiment, area 213 is only served by spot 1 at a first point in time illustrated by FIG. 6B. At a second point in time illustrated by FIG. 6C, the spots have been shifted such that area 213 is now served or covered by spots 1, 2, and 3. In this embodiment, terrestrial transceivers in area 213 may be adjusted such that some of the transceivers are served by spot 1, others by spot 2, and yet others by spot 3. In other words, transceivers in area 213 may be selectively assigned one of three colors. In this manner, the load in this area can be shared or load-balanced.

In an exemplary embodiment, the switching of the satellites and/or terminals may occur with any regularity. For example, the polarization may be switched during the evening hours, and then switched back during business hours to reflect transmission load variations that occur over time. In an exemplary embodiment, the polarization may be switched thousands of times during the life of elements in the system.

In one exemplary embodiment, the color of the terminal is not determined or assigned until installation of the terrestrial transceiver. This is in contrast to units shipped from the factory set as one particular color. The ability to ship a terrestrial transceiver without concern for its “color” facilitates simpler inventory processes, as only one unit (as opposed to two or four or more) need be stored. In an exemplary embodiment, the terminal is installed, and then the color is set in an automated manner (i.e. the technician can't make a human error) either manually or electronically. In another exemplary embodiment, the color is set remotely such as being assigned by a remote central control center. In another exemplary embodiment, the unit itself determines the best color and operates at that color.

As can be noted, the determination of what color to use for a particular terminal may be based on any number of factors. The color may based on what signal is strongest, based on relative bandwidth available between available colors, randomly assigned among available colors, based on geographic considerations, based on temporal considerations (such as weather, bandwidth usage, events, work patterns, days of the week, sporting events, and/or the like), and or the like. Previously, a terrestrial consumer broadband terminal was not capable of determining what color to use based on conditions at the moment of install or quickly, remotely varied during use.

In accordance with an exemplary embodiment, the system is configured to facilitate remote addressability of subscriber terminals. In one exemplary embodiment, the system is configured to remotely address a specific terminal. The system may be configured to address each subscriber terminal. In another exemplary embodiment, a group of subscriber terminals may be addressable. This may occur using any number of methods now known, or hereafter invented, to communicate instructions with a specific transceiver and/or group of subscriber terminals. Thus, a remote signal may command a terminal or group of terminals to switch from one color to another color. The terminals may be addressable in any suitable manner. In one exemplary embodiment, an IP address is associated with each terminal. In an exemplary embodiment, the terminals may be addressable through the modems or set top boxes (e.g. via the internet). Thus, in accordance with an exemplary embodiment, the system is configured for remotely changing a characteristic polarization of a subscriber terminal by sending a command addressed to a particular terminal. This may facilitate load balancing and the like. The sub-group could be a geographic sub group within a larger geographic area, or any other group formed on any suitable basis

In this manner, an individual unit may be controlled on a one to one basis. Similarly, all of the units in a sub-group may be commanded to change colors at the same time. In one embodiment, a group is broken into small sub-groups (e.g., 100 sub groups each comprising 1% of the terminals in the larger grouping). Other sub-groups might comprise 5%, 10%, 20%, 35%, 50% of the terminals, and the like. The granularity of the subgroups may facilitate more fine tuning in the load balancing.

Thus, an individual with a four color switchable transceiver that is located at location A on the map (see FIG. 5, Practical Distribution Illustration), would have available to them colors U1, U2, and U3. The transceiver could be switched to operate on one of those three colors as best suits the needs at the time. Likewise, location B on the map would have colors U1 and U3 available. Lastly, location C on the map would have color U1 available. In many practical circumstances, a transceiver will have two or three color options available in a particular area.

It should be noted that colors U5 and U6 might also be used and further increase the options of colors to use in a spot beam pattern. This may also further increase the options available to a particular transceiver in a particular location. Although described as a four or six color embodiment, any suitable number of colors may be used for color switching as described herein. Also, although described herein as a satellite, it is intended that the description is valid for other similar remote communication systems that are configured to communicate with the transceiver.

The frequency range/polarization of the terminal may be selected at least one of remotely, locally, manually, or some combination thereof. In one exemplary embodiment, the terminal is configured to be remotely controlled to switch from one frequency range/polarization to another. For example, the terminal may receive a signal from a central system that controls switching the frequency range/polarization. The central system may determine that load changes have significantly slowed down the left hand polarized channel, but that the right hand polarized channel has available bandwidth. The central system could then remotely switch the polarization of a number of terminals. This would improve channel availability for switched and non-switched users alike. Moreover, the units to switch may be selected based on geography, weather, use characteristics, individual bandwidth requirements, and/or other considerations. Furthermore, the switching of frequency range/polarization could be in response to the customer calling the company about poor transmission quality.

It should be noted that although described herein in the context of switching both frequency range and polarization, benefits and advantages similar to those discussed herein may be realized when switching just one of frequency or polarization.

The frequency range switching described herein may be performed in any number of ways. In an exemplary embodiment, the frequency range switching is performed electronically. For example, the frequency range switching may be implemented by adjusting phase shifters in a phased array, switching between fixed frequency oscillators or converters, and/or using a tunable dual conversion transmitter comprising a tunable oscillator signal. Additional aspects of frequency switching for use with the present invention are disclosed in U.S. application Ser. No. 12/614,293 entitled “DUAL CONVERSION TRANSMITTER WITH SINGLE LOCAL OSCILLATOR” which was filed on Nov. 6, 2009; the contents of which are hereby incorporated by reference in their entirety.

In accordance with another exemplary embodiment, the polarization switching described herein may be performed in any number of ways. In an exemplary embodiment, the polarization switching is performed electronically by adjusting the relative phase of signals at orthogonal antenna ports. In another exemplary embodiment, the polarization switching is performed mechanically. For example, the polarization switching may be implemented by use of a trumpet switch.

For instance, in one exemplary embodiment the system may be configured to communicate over commercial bandwidth demands (such as 17.7-20.2 GHz, and/or 27.5-30.0 GHz) using mechanical steering utilizing a trumpet switch. In this exemplary embodiment a phased array may be configured to have low noise amplifiers and power amplifiers at respective elements. The phased array may centrally form circular polarization using all or a portion of all of the receive vertical and horizontal ports. The phased array may separately centrally form circular polarization using all or a portion of all of the transmit vertical and horizontal ports.

The trumpet switch may be actuated electronically. For example, the trumpet switch may be actuated by electronic magnet, servo, an inductor, a solenoid, a spring, a motor, an electro-mechanical device, or any combination thereof. Moreover, the switching mechanism can be any mechanism configured to move and maintain the position of trumpet switch. Furthermore, in an exemplary embodiment, trumpet switch is held in position by a latching mechanism. The latching mechanism, for example, may be fixed magnets. The latching mechanism keeps trumpet switch in place until the antenna is switched to another polarization.

As described herein, the terminal may be configured to receive a signal causing switching and the signal may be from a remote source. For example, the remote source may be a central office. In another example, an installer or customer can switch the polarization using a local computer connected to the terminal which sends commands to the switch. In another embodiment, an installer or customer can switch the polarization using the television set-top box which in turn sends signals to the switch. The polarization switching may occur during installation, as a means to increase performance, or as another option for troubleshooting poor performance.

In other exemplary embodiments, manual methods may be used to change a terminal from one polarization to another. This can be accomplished by physically moving a switch within the housing of the system or by extending the switch outside the housing to make it easier to manually switch the polarization. This could be done by either an installer or customer.

Some exemplary embodiments of the above mentioned multi-color embodiments may benefits over the prior art. For instance, in an exemplary embodiment, a low cost consumer broadband terrestrial terminal antenna system may include an antenna, a transceiver in signal communication with the antenna, and a polarity switch configured to cause the antenna system to switch between a first polarity and a second polarity. In this exemplary embodiment, the antenna system may be configured to operate at the first polarity and/or the second polarity.

In an exemplary embodiment, a method of system resource load balancing is disclosed. In this exemplary embodiment, the method may include the steps of: (1) determining that load on a first spotbeam is higher than a desired level and that load on a second spotbeam is low enough to accommodate additional load; (2) identifying, as available for switching, consumer broadband terrestrial terminals on the first spot beam that are in view of the second spotbeam; (3) sending a remote command to the available for switching terminals; and (4) switching color in said terminals from the first beam to the second beam based on the remote command. In this exemplary embodiment, the first and second spot beams are each a different color.

In an exemplary embodiment, a satellite communication system is disclosed. In this exemplary embodiment, the satellite communication system may include: a satellite configured to broadcast multiple spotbeams; a plurality of user terminal antenna systems in various geographic locations; and a remote system controller configured to command at least some of the subset of the plurality of user terminal antenna systems to switch at least one of a polarity and a frequency to switch from the first spot beam to the second spotbeam. In this exemplary embodiment, the multiple spot beams may include at least a first spotbeam of a first color and a second spotbeam of a second color. In this exemplary embodiment, at least a subset of the plurality of user terminal antenna systems may be located within view of both the first and second spotbeams.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, couple may mean that two objects are in communication with each other, and/or communicate with each other, such as two pieces of hardware. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

It should be appreciated that the particular implementations shown and described herein are illustrative of various embodiments including its best mode, and are not intended to limit the scope of the present disclosure in any way. For the sake of brevity, conventional techniques for signal processing, data transmission, signaling, and network control, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

The following applications are related to this subject matter: U.S. application Ser. No. 12/614,185, entitled “MOLDED ORTHOMODE TRANSDUCER,” which was filed on Nov. 6, 2009; U.S. Provisional Application No. 61/113,517, entitled “MOLDED ORTHOMODE TRANSDUCER,” which was filed on Nov. 11, 2008; U.S. Provisional Application No. 61/112,538, entitled “DUAL CONVERSION TRANSMITTER WITH SINGLE LOCAL OSCILLATOR,” which was filed on Nov. 7, 2008; U.S. application Ser. No. ______, entitled “ELECTROMECHANICAL POLARIZATION SWITCH,” which is being filed contemporaneously herewith (docket no. 36956.8200); U.S. application Ser. No. ______, entitled “ACTIVE PHASED ARRAY ARCHITECTURE,” which is being filed contemporaneously herewith (docket no. 36956.6500); U.S. application Ser. No. ______, entitled “DUAL-POLARIZED, MULTI-BAND, FULL DUPLEX, INTERLEAVED WAVEGUIDE APERATURE,” which is being filed contemporaneously herewith (docket no. 55424.0900); U.S. application Ser. No. ______, entitled “ACTIVE BUTLER AND BLASS MATRICES,” which is being filed contemporaneously herewith (docket no. 36956.7100); U.S. application Ser. No. ______, entitled “ACTIVE HYBRIDS FOR ANTENNA SYSTEMS,” which is being filed contemporaneously herewith (docket no. 36956.7200); U.S. application Ser. No. ______, entitled “ACTIVE FEED FORWARD AMPLIFIER,” which is being filed contemporaneously herewith (docket no. 36956.7300); U.S. application Ser. No. ______, entitled “ACTIVE PHASED ARRAY ARCHITECTURE,” which is being filed contemporaneously herewith (docket no. 36956.7600); U.S. application Ser. No. ______, entitled “PRESELECTOR AMPLIFIER,” which is being filed contemporaneously herewith (docket no. 36956.6800); U.S. application Ser. No. ______, entitled “ACTIVE POWER SPLITTER,” which is being filed contemporaneously herewith (docket no. 36956.8700); U.S. application Ser. No. ______, entitled “HALF-DUPLEX PHASED ARRAY ANTENNA SYSTEM,” which is being filed contemporaneously herewith (docket no. 55424.0500); U.S. application Ser. No. ______, entitled “DIGITAL AMPLITUDE CONTROL OF ACTIVE VECTOR GENERATOR,” which is being filed contemporaneously herewith (docket no. 36956.9000); the contents of which are hereby incorporated by reference for any purpose in their entirety.

While the principles of the disclosure have been shown in embodiments, many modifications of structure, arrangements, proportions, the elements, materials and components, used in practice, which are particularly adapted for a specific environment and operating requirements without departing from the principles and scope of this disclosure. These and other changes or modifications are intended to be included within the scope of the present disclosure and may be expressed in the following claims.

1. A phased array illuminated reflector dish RF antenna system, comprising:
a phased array, wherein said phased array is connected in communication with one of a transmitter, a receiver, and a transceiver;
a microwave reflector dish; and
a boom arm supporting said phased array and said microwave reflector dish;
wherein said phased array only communicates signals with a remote source of said signals via said microwave reflector dish, and not directly; wherein the RF antenna system is configured to be rough pointed by mechanically aiming said RF antenna system, and wherein the RF antenna system is configured to fine tune aim the beam of said RF antenna system by beam steering.

2. The system according to claim 1, wherein said beam steering optimizes the performance of the phased array reflector dish RF antenna system.

3. The system according to claim 1, wherein said beam steering improves reception in the phased array reflector dish RF antenna system compared to a reflector dish RF antenna system that does not use electronic aiming.

4. The system according to claim 1, wherein said beam steering reduces transmission interference of the phased array reflector dish RF antenna system compared to a reflector dish RF antenna system that does not use electronic aiming.

5. The system according to claim 1, wherein said beam steering increases service availability, channel capacity or service quality of the phased array reflector dish RF antenna system compared to a reflector dish RF antenna system that does not use electronic aiming.

6. The system according to claim 1, wherein said phased array reflector dish RF antenna system further comprises mechanical alignment components for use to rough aim said phased array reflector dish RF antenna system.

7. The system according to claim 1, wherein said system does not comprise an OMT, polarizer, and feed horn.

8. The system according to claim 1, wherein said transmitter is a block up converter and wherein said receiver is a low noise block down converter.

9. The system according to claim 1, wherein said fine tune aiming of the beam of said RF antenna system is based on maximizing the receive signal strength.

10. The system according to claim 1, wherein said RF system is one of a point to point system and a point to satellite system.

11. The system according to claim 1, wherein said system installation can be performed (a) in less time, (b) for less cost, (c) with a lower skill set, and/or (d) more likely by self install—than installation of a comparable performance system that does not combine a phased array with a microwave reflector dish and use beam steering for alignment.

12. The system according to claim 1, wherein said system is configured to facilitate aiming the antenna in an automated manner.

13. The system according to claim 1, wherein said system is configured to facilitate re-adjusting the alignment of the antenna at a time subsequent to the installation and original alignment.

14. A method of aligning an RF transmission antenna system, comprising:
rough aiming an antenna, via mechanical methods, approximately at the target, wherein said antenna is a phased array reflector dish RF antenna system; and
fine tuning the alignment of said antenna by beam steering, wherein said fine tuning is based on feedback indicating the quality of the current aiming of said antenna.

15. The method according to claim 14, where in said fine tuning is based on an algorithm for maximizing the signal strength of a receive signal.

16. The method according to claim 14, wherein said feedback comprises information regarding the strength of a signal received by said antenna system.

17. A method for communicating RF signals comprising:
receiving a transmit signal from a modem at a transmitter;
upconverting said transmit signal in said transmitter;
transmitting said signal via a transmit portion of a phased array antenna combined with a reflector dish;
beam steering to aim said signal of said phased array antenna combined with said reflector dish at a satellite;
receiving a receive signal from said satellite;
beam steering to aim a receive portion of a phased array antenna combined with a reflector dish;
down converting said receive signal from said satellite.

18. A method for aligning an RF antenna system comprising:
rough aiming the RF antenna system, wherein the RF antenna system comprises a phased array, transceiver, and a reflector dish; and
fine turning of the aim of the RF antenna system by electronically beam steering.

19. A terrestrial microwave communications terminal for aligning an RF antenna system comprising:
a solid state, non-motorized pointing system having fine pointing/automated peaking capability.

20. The terrestrial microwave communications terminal of claim 19, wherein said terrestrial terminal comprises a point to point terminal.

21. The terrestrial microwave communications terminal of claim 19, wherein said terrestrial terminal comprises a ground terminal configured for communication with a satellite.

22. A terrestrial microwave communications terminal comprising:
a phased array, wherein said phased array is connected in communication with one of a transmitter, a receiver, and a transceiver;
a microwave reflector dish; and
a boom arm supporting said phased array and said microwave reflector dish;
wherein said phased array only communicates signals with a remote source of said signals via said microwave reflector dish, and not directly; and wherein said antenna system is configured to electronically switch polarization of said integrated phased array feed transceiver; and
wherein said terrestrial microwave communications terminal is one of a point to point terminal and a satellite terminal.

23. The antenna system of claim 22, wherein the RF antenna system is configured to be rough pointed by mechanically aiming said RF antenna system, and wherein the RF antenna system is configured to fine tune aim the beam of said RF antenna system by beam steering.
